(19) United States
(12) Patent Application Publication
(10) Pub. No.: US 2022/0017129 A1
(43) Pub. Date: Jan. 20, 2022

(54) Onboard Railway Health Monitoring

(71) Applicant: Zahid F. Mian, Loudonville, NY (US)

(72) Inventor: Zahid F. Mian, Loudonville, NY (US)

(21) Appl. No.: 17/373,963

(22) Filed: Jul. 13, 2021

Related U.S. Application Data
(60) Provisional application No. 63/052,100, filed on Jul. 15, 2020.

(51) Int. Cl. B61L 15/00; B61L 27/00; B61L 25/02; G06N 20/00

(52) U.S. Cl. CPC B61L 15/0081; B61L 15/0072; B61L 27/0083; B61L 2205/04; B61L 25/021; G06N 20/00; B61L 27/0005

(57) ABSTRACT

A system and method for on-board or rail-side monitoring of train track, wheels, running gear, and other railway systems' component health by constant monitoring of acoustic, vibration, and potentially other modalities is described. These data are then processed to arrive at the track health data per track location, arrive at specific vehicle component health, and ride quality data from either passenger comfort or cargo damage protection of view.

### REFERENCE TO RELATED APPLICATIONS

The current application claims the benefit of U.S. Provisional Application No. 63/052,100, filed on 15 Jul. 2020, which is hereby incorporated by reference herein.

### TECHNICAL FIELD

The disclosure relates generally to the detection and identification of issues relevant to the health of railway components from a moving railway vehicle.

### BACKGROUND OF THE INVENTION

In railway operations, the condition of the track and of the wheels is an important safety concern. A damaged section of track or damaged wheel can result in a serious accident, even derailment. Even in the absence of an actual mishap, ride quality for passengers or freight is affected.

Track or wheel condition hazards often do not develop suddenly, but rather develop over a period of time. By monitoring track and wheel quality constantly, trending may be used to anticipate hazards before they become serious. This serves both to prevent accidents and to reduce repair costs. This monitoring may be done using optical techniques, vibration sensing, audio analysis, or other sensor techniques.

Track quality is currently assessed using specialized “geometry cars”, which scan the rails as they travel. While thorough, these cars can only scan the track by riding over it, which can't provide total coverage.

Wheel quality is currently assessed using wayside monitors, which optically scan the wheels as they pass a fixed location. For a given wheel, this provides only episodic coverage.

The present invention provides a mobile monitoring unit which is small and inexpensive enough to install on large numbers of rail cars. This provides continuous monitoring of the car's wheels over an extended time period. Moreover, installation of this unit on a large proportion of a rail fleet can provide rail quality monitoring over all track traversed by any of the cars.

### SUMMARY OF THE INVENTION

The following application describes an on-board system which monitors train track, wheels, running gear, and other railway systems' component health by constantly listening in on the acoustic sounds as well as the vibrations emitted by various components. These sounds as well as vibrations are then processed to arrive at the track health data per track location, arrive at specific vehicle component health (e.g. wheel flatspots), and ride quality data from either passenger comfort or cargo damage protection of view. It is also shown that an alternative embodiment of the system may be based on the rails and/or supporting structures as well as on-board a rail vehicle.

Track Measurements: By using the described approach, the system gathers the sounds and then processes them to arrive at the following track attributes. All attributes are adjusted for the speed of the train at the time measurements are taken and also adjusted for track parameters to normalize the track sound data:

1. Peak noise level for the entire track segment under observation

2. Average noise level for various track segments based on a running average over a set distance

3. Compute track quality index (TQI) which calculates the instantaneous track noise with the average noise. TQI help prioritize rail grindings and verify rail noise reduction

4. Frequency content of the sound/noise data

Vibration Monitoring: Remote vibration monitoring units may be installed on rail vehicle components (e.g., axle boxes, railcar body, etc.), to measure both track and wheel quality. They would convey their collected data to the centralized acoustic monitoring unit for correlation and/or aggregation with the acoustic data. The data may be conveyed by wired or wireless communication. The units may be powered by wires, battery, or power harvesting.

Axle box vibration monitoring provides information directly from the track, without intervening suspension (called “unsprung” in the field) which can more easily allow detection of both wheel defects—flat spots, out of round, spalls—and track defects—squats, corrugation, and deteriorating welds.

Optical Scanning: By co-locating a laser-camera pair at the truck, and using structured light techniques, the surface of the rail may be scanned in real time for anomalies.

Deep learning to recognize track anomalies: Accurate automatic defect recognition can be performed with the help of deep learning algorithms. Deep learning consists of training an algorithm with a variety of data points (defects and non-defects) which learns important features from each class without being explicitly programmed by humans.

Deep learning techniques usually involve a form of Neural Network such as Artificial Neural Networks (ANNS), Convolutional Neural Networks (CNNs) and Long Short Term Memory (LSTM) networks. The latter can learn long-term temporal dependencies by utilizing special mechanisms called memory cells which is particularly important in the application of vibrational defect detection.

The deep learning process may consist of four stages: (1) collection of data in both defect and non-defect conditions; (2) pre-processing of vibrational data aimed at extracting characteristics of the train wheels and tracks (i.e. speed, wheel number, etc.); (3) training of Neural Networks (4) detection of defects in the wheels and tracks in current condition through the comparison between predicted and measured responses in real-time or near real-time.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1: Illustrates a bottom view of a railcar showing the onboard monitoring unit

FIG. 2: Illustrates a component view of an onboard monitoring unit, including acoustic, vibration, and optical sensor units.

FIG. 3: Illustrates a component view of a location processing unit

FIG. 4: Illustrates data flow for deep learning

FIG. 5: Illustrates signal analysis of vibration and acoustic data

FIG. 6: Illustrates a design for optical rail scanning

FIG. 7: Illustrates processing for optical rail scanning

FIG. 8: Illustrates sample rail monitor results

FIG. 9: Illustrates an alternate embodiment with 2 microphones

FIG. 10: Illustrates an alternate embodiment with 1 microphone

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

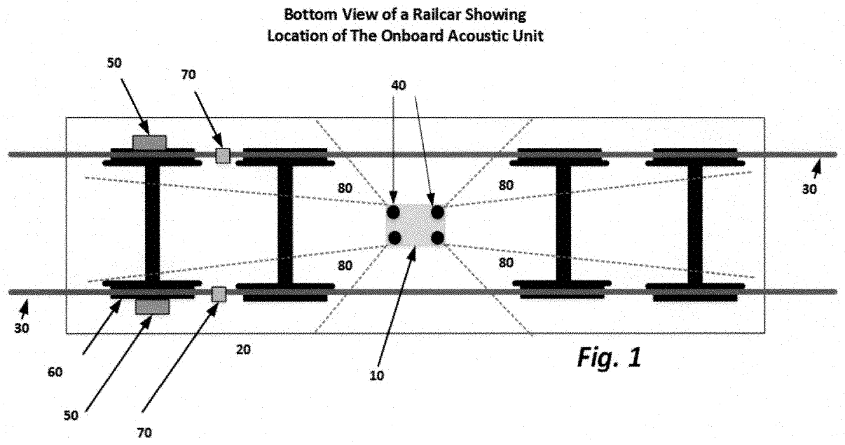

In FIG. 1, the preferred embodiment is depicted, in which the onboard monitoring unit 10 is mounted to the bottom of the car body 20, roughly midway between the tracks 30 using mounting magnets 40.

Wheelset axle box monitoring units 50 are mounted to the axle ends of at least one wheelset 60 to measure the unsprung vibration from the wheels and track. In the preferred embodiment, these units 50 are wireless, powered via batteries, power harvesting, or a combination thereof. This allows the units to be installed quickly, easily, and cheaply, with no requirement of installed power infrastructure in such locations. This also allows the present invention to be made available either as a product (monitoring devices) or a service (data gathering and analysis based on such devices).

At least one optical track measurement unit 70 is mounted to the car body 20 (sprung) in view of the track head. Such a unit 70 allows a direct examination of visible features (cracks, gouges, wear, etc.) on the track. In addition, axle box monitoring units 50 can monitor and extract vibration due to the track from the signals; this is feasible for a number of reasons, the most obvious being that track signals will not repeat in a cycle in-phase with the rotation of the wheels (or some particular ratio thereof, such as in the case of worn bearing signals).

Mounting near the middle of the car provides microphone reception fields 80 which can monitor all wheelsets 50. This is in addition to the reception of vibrations transmitted through the car body 20, providing an additional source of data for cross-checking received vibration signals, and also provides some directionality for signals, allowing specific vibration/acoustic signals to be assigned to particular wheels.

It should be noted that the system is modular in design. It could be implemented with vibration and acoustic monitoring units 50 alone, or with the optical units 70, or the units 50 could be implemented as solely vibration or solely acoustic devices.

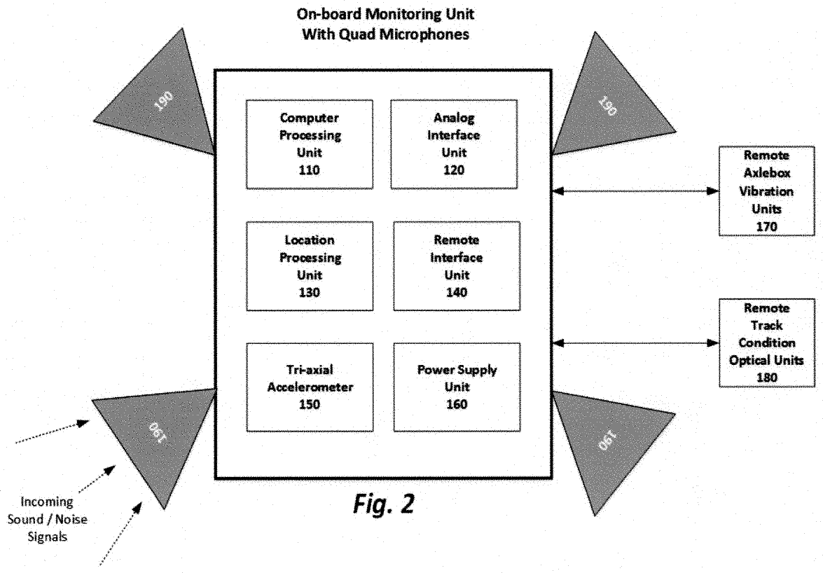

FIG. 2 depicts components of an embodiment of the onboard monitoring unit. A computer processing unit 110 serves as an aggregator of the incoming signals. The analog interface unit 120 performs analog processing for microphones 190 and conveys the data to the computer processing unit 110.

The location processing unit 130 computes location based on available sources, which may include GNSS, IMU (dead-reckoning), or RFID tags, and conveys this location information to the computer processing unit 110. By tagging the data from the other sensors with geographic information, the location of a track anomaly can be deduced.

The remote interface unit 140 provides a wired or wireless link between the computer processing unit 110 and a data repository. In a preferred embodiment, the data will be passed over a wireless link, such as WiFi, to a network access point in a station or wayside unit. It is, however, also possible for the data to be conveyed via a direct connection (USB, Ethernet, removable memory card, etc.) whenever the vehicle is stopped in an appropriate location. The tri-axial accelerometer unit 150 provides vibration and impact detection which may be analyzed independently and/or correlated with detected acoustic signals. The power supply unit 160 stores and distributes power to the other components of the system. The remote axle box vibration units 170 convey axle box (unsprung) vibration data to the computer processing unit 110. The remote track condition optical units 180 convey data from their optical sensors to the computer processing unit 110. Primary acoustic data is gathered by the four directional microphones 190.

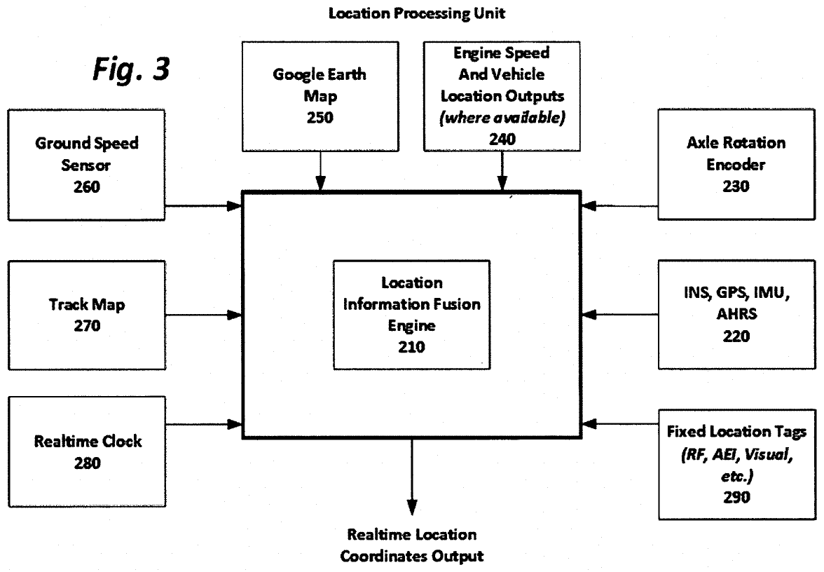

FIG. 3 shows a component view of the location processing unit. This unit accepts input from at least one location reference source, and the location information fusion engine 210 fuses this data to compute the railcar's current location. Input sources may include GNSS 220, an encoder measuring axle rotation 230, engine speed and vehicle location outputs 240, Google Earth maps 250, a ground speed sensor 260, a track map 270, a real-time clock 280, and/or location tags 290 fixed along the track route, or any other device or method which may allow a determination or refinement of position.

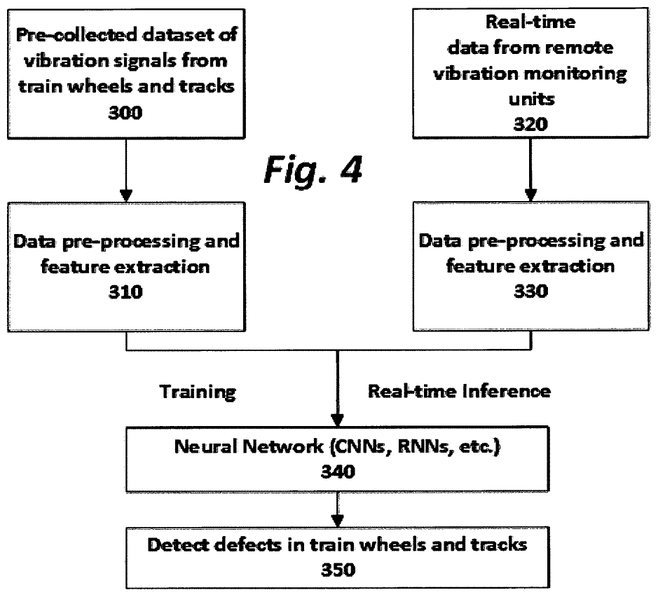

FIG. 4 shows the steps for deep learning analysis for vibration data. As preparation, training data 300 is collected and features extracted 310 for subsequent training to produce a matching neural network 340. In real time, as the train travels, data 320 is collected from the vibration monitors and features 330 are extracted from it. This set of features is provided to the pre-computed network 340 to produce a detection result 350 reflecting defects in the train wheels and tracks.

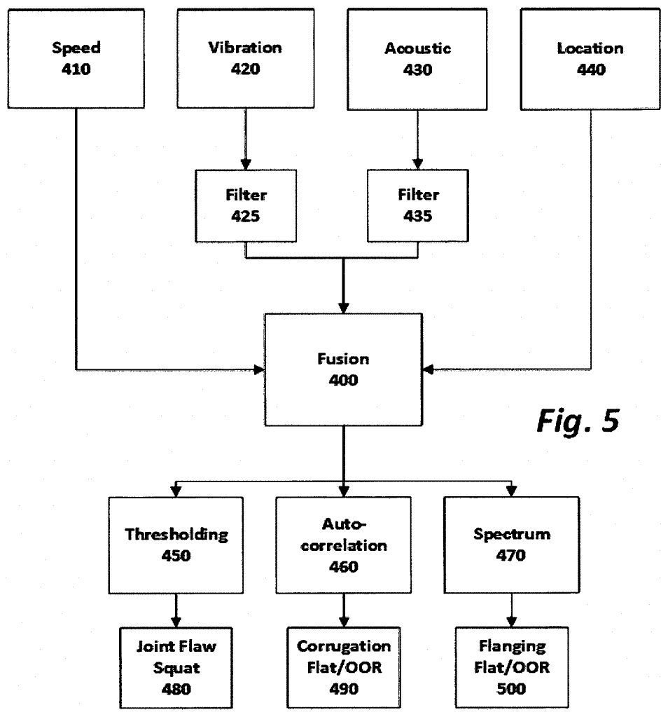

FIG. 5 shows the signal processing analysis for vibration and acoustic data. Input data is matched by time in the fusion step 400. The input data consists of speed 410, vibration 420, acoustic 430 and location 440. Vibration and acoustic data are filtered to remove noise before processing by filters 425 and 435 respectively.

The fused data is analyzed for different properties. Thresholding 450 provides information for transient anomalies such as flawed joints and squats 480. Autocorrelation 460 detects rail corrugation and wheels which are flat or out of round 490. Spectral analysis 470 detects wheel/rail flanging and flat or out of round wheels 500.

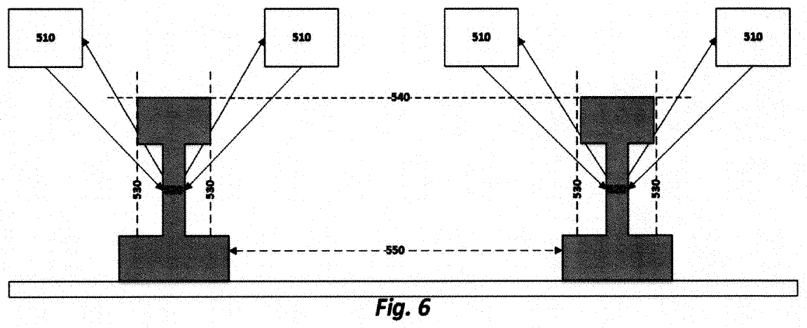

FIG. 6 depicts schematically the physical design for optical rail scanning. Each rail is scanned by at least one laser/camera pair 510, preferentially mounted to the car body, wherein the laser is aimed at an angle to the rail 520, and the image of the laser incident on the rail surface is captured by the camera. The use of structured light techniques provides a measurement of the cant angle 530. Combining the measurements from the two rails provides common level 540 and gauge 550.

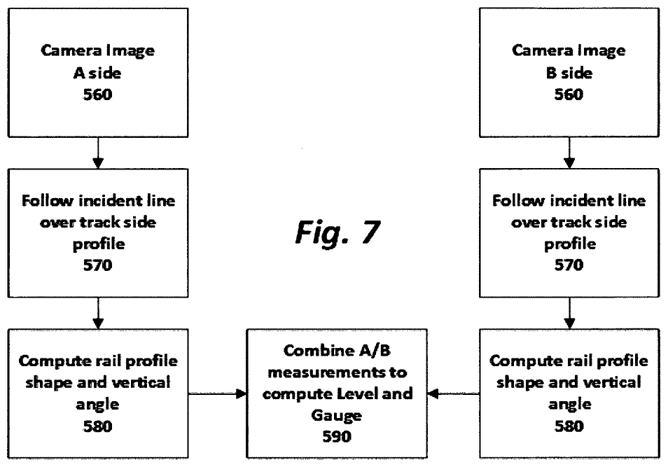

FIG. 7 depicts the processing of the optical data. The captured camera images 560 are analyzed 570 to locate and follow the laser line image over the track side profile surface. The laser line image is used to compute 580 the rail side profile shape and the vertical angle. The measurements from the A and B side rails are combined 590 to compute the traction level angle and distance between the rails.

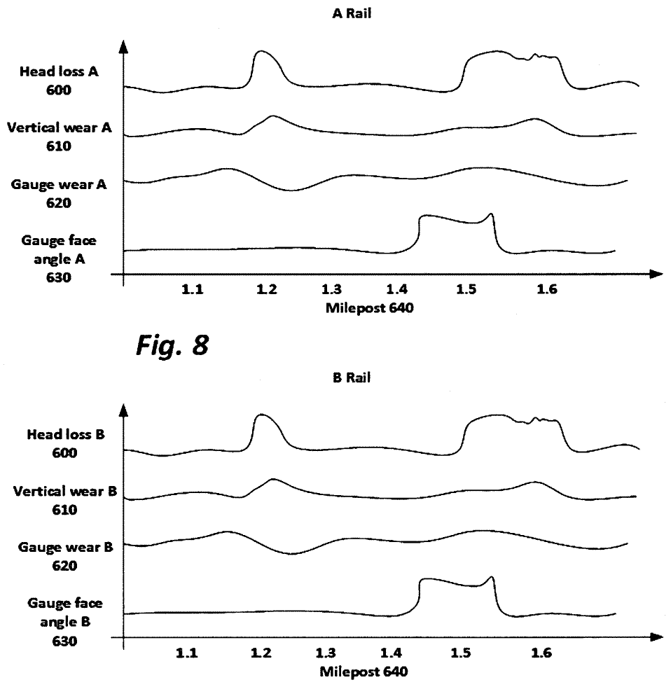

FIG. 8 presents a sample intended output. The rail quality is presented using 4 properties—Head Loss 600, Vertical Wear 610, Gauge Wear 620, Gauge Face Angle 630—for each of the two rails over a 1.8 mile length of track by Milepost 640. A report of this nature can serve to advise railroad service personnel of rail anomalies so that they may be targeted for repair before they become critical.

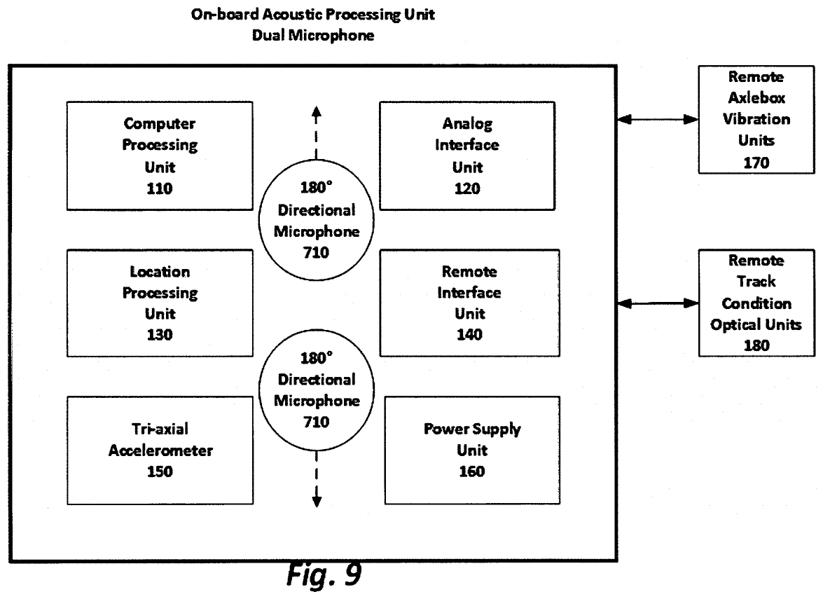

FIG. 9 presents an alternate embodiment of the on-board monitoring unit depicted in FIG. 2, wherein the four directional microphones 190 have been replaced with two 180° directional microphones 710, which can reduce cost and data requirements.

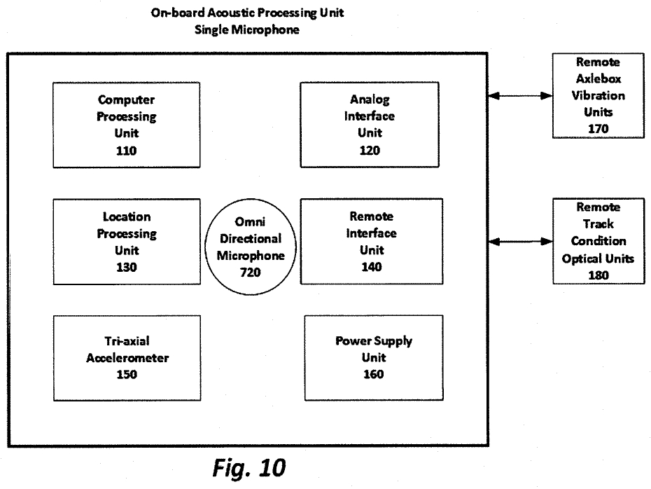

FIG. 10 presents an alternate embodiment of the on-board monitoring unit depicted in FIG. 2, wherein the four directional microphones 190 have been replaced with a single omnidirectional microphone 720, which can reduce cost and data requirements.

There are numerous embodiments of this innovative system:

In a preferred embodiment, the system can be installed under a vehicle in the middle to allow easy capture of all sounds from wheel-rail interaction. The sounds are then processed by the system and correlated with the track position.

In another embodiment, the system can be installed inside a vehicle to allow easy capture of all sounds from wheel-rail interaction. By measuring the noise levels inside a vehicle, the relative loudness of the entire system can be gathered efficiently. The speed data is used to map the noise levels to specific locations on the system. The sounds are then processed by the system and correlated with the track position. In addition, gathering data from within a vehicle such as a passenger car will also provide data on ride quality.

In another embodiment, vibration detectors are mounted on the axle box (unsprung) and convey vibration data resulting from wheel or track anomalies to the aggregation node.

In one embodiment, the system uses 16-bit analog to digital conversion while in another embodiment, the system uses 24-bit or 32-bit A2D conversion to digitize sounds with very high fidelity.

In another embodiment, the sensor units 50 may be installed at a stationary location, such as on or just below the track surface, where vibrations, acoustic signals, and/or images (with or without laser lines) may be gathered from passing trains. This allows the system to gather short but useful segments of data on multiple railcars and long-term monitoring of the relevant section of rail.

In yet another embodiment, the described system may be incorporated into other large vehicles, such as commercial vehicles (trucks), and thus be used to monitor both the performance of components of the vehicle and the condition of the roadway surface over which the vehicle passes, with similar benefits for the vehicle owner and the maintainers of the road.

The foregoing description of various embodiments of this invention has been presented for purposes of illustration and description. It is not intended to be exhaustive or to limit the invention to the precise form disclosed and inherently many more modifications and variations are possible. All such modifications and variations that may be apparent to persons skilled in the art that are exposed to the concepts described herein or in the actual work product, are intended to be included within the scope of this invention disclosure.

What is claimed is:

1) A system for monitoring railway equipment condition, comprising:
at least one data acquisition and aggregation unit attached to a rail car;
an analysis system for analysis and fusion of acquired sensor data to assess rail car and/or track condition; and
analyzing the data for characterization of the rail and or track status.

2) The system of claim 1, in which the data acquisition unit acquires at least one of vibration, acoustic, and imaging data.

3) The system of claim 2, in which the data for analysis includes data from a location sensing system (GPS and/or IMU) or speed input from the vehicle.

4) The system of claim 2, in which the data is processed to separate signal data from the rail car and track source or sources.

5) The system of claim 4, in which the separate data is analyzed to determine the condition of rail car and/or track components.

6) The system of claim 5, in which the system can communicate with at least one of the following, either installed on the device or on a remote system: deep learning system, artificial intelligence system, and an expert system.

7) The system of claim 5, in which conditions of rail car include at least one attribute relating to flat spots, damaged or failing bearings, flanging, vehicle suspension anomalies such as sway, failure of dampers, and other rail car component status.

8) A system for monitoring railway equipment condition, comprising:
at least one data acquisition and aggregation unit attached to or in proximity to the rail track;
an analysis system for analysis and fusion of acquired sensor data to assess rail car and/or track condition; and
analyzing the data for characterization of the rail and or track status.

9) The system of claim 8, in which the data acquisition unit acquires at least one of vibration, acoustic, and imaging data.

10) The system of claim 9, in which the data for analysis includes data or speed input of a vehicle.

11) The system of claim 9, in which the data is processed to separate signal data from the rail car and track source or sources.

12) The system of claim 11, in which the separate data is analyzed to determine the condition of rail car and/or track components.

13) The system of claim 12, in which the system can communicate with at least one of the following, either installed on the device or on a remote system: deep learning system, artificial intelligence system, and an expert system.

14) The system of claim 13, in which conditions of rail car include at least one attribute relating to flat spots, damaged or failing bearings, flanging, vehicle suspension anomalies such as sway, failure of dampers, and other rail car component status.

15) A method for monitoring a railcar or railroad track, the method comprising:
at least one sensor mounted or connected to a railcar;
generating electrical signals corresponding to the sensor data;
analyzing the generated electrical signals to extract at least one feature of the generated signals;
comparing at least one feature to a plurality of rail component condition anomalies.

16) The method of claim 15, wherein the signals generated by the anomaly comprise one of acoustic, vibration, or image signals.

17) The method of claim 15, wherein the analysis of the signals uses deep learning or artificial intelligence.

18) The method of claim 15, wherein analyzing the generated electrical signals to extract at least one feature of the generated signals comprises vehicle crash or derailment analysis.

19) The method of claim 15, wherein the plurality of anomalies comprises at least one of an anomaly for vehicle components or attributes relating to flat spots, damaged or failing bearings, flanging, vehicle suspension anomalies such as sway, failure of dampers, and other rail car component status.
